(19) United States
(12) Patent Application Publication
(10) Pub. No.: US 2015/0210518 A1
(43) Pub. Date: Jul. 30, 2015

(54) ANTI-OVERPRESSURE DOUBLE-ACTING THREADED JACK

(71) Applicant: CHUNG-YI YANG, NEW TAIPEI CITY (TW)

(72) Inventor: CHUNG-YI YANG, NEW TAIPEI CITY (TW)

(21) Appl. No.: 14/164,609

(22) Filed: Jan. 27, 2014

(51) Int. Cl. B66F 3/25

(52) U.S. Cl. CPC B66F 3/25

(57) ABSTRACT

A double-acting threaded jack includes an outer cylinder having a liquid guiding hole, an inner piston rod installed at the center of the outer cylinder, a lifting piston rod sheathed on the inner piston rod, and a pressure relief module installed in the outer cylinder; a liquid guiding pipeline passing through the inner piston rod; and first and second hydraulic chambers formed between the lifting piston rod and the inner piston rod. A liquid is filled from the liquid guiding pipeline into the first/second hydraulic chamber to descend/ascend the lifting piston rod respectively. The pressure relief module has an adjusting member with a through hole, a stop member for stopping the liquid guiding pipeline, and a spring installed between the adjusting member and the stop member. The liquid will push open the stop member and discharge from the through hole of the adjusting member in an overpressure situation.

### FIELD OF TECHNOLOGY

The present invention relates to a jack, in particular to an anti-overpressure double-acting threaded jack capable of solving the internal pipeline overpressure problem to prevent the double-acting threaded jack from being damaged by overpressure.

### BACKGROUND

In general, after a hydraulic jack is used for lifting heavy objects, a locking element is used for fixing the jack, and then the hydraulic pressure in the jack. When a user wants to store the jack, the user simply loosens the locking element for the storage, but it is difficult to resume the position of a lifted jack back to the bottom.

In addition, a hydraulic pipeline and an oil storage tank (power source) may be clogged easily, so that the hydraulic pressure cannot be distributed or the jack cannot be used.

If the pipeline is clogged, and the user continues filling an oily liquid into the jack, the jack will not be operated, and a secondary cylinder and a primary cylinder have different pressure exerting areas, and thus the structure of the jack is damaged.

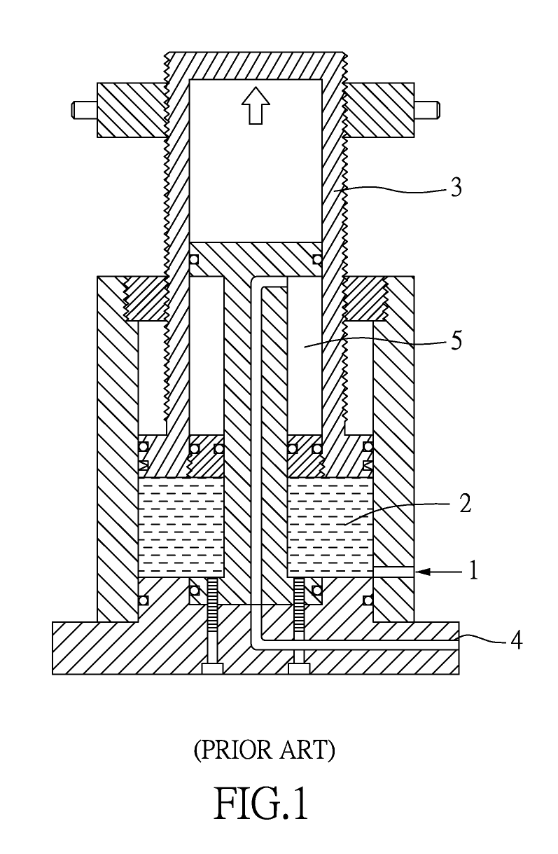

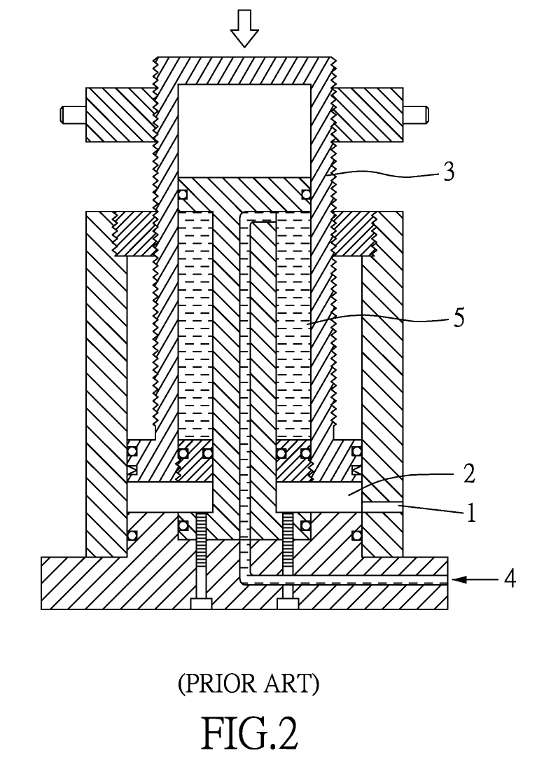

More specifically, a conventional double-acting jack as shown in FIG. 1 fills oil from an oil inlet hole 1 into a main oil chamber 2 to lift a jack lifting shaft 3. In FIG. 2, when the jack lifting shaft 3 is descended, a descending oil channel 4 is provided for filling other oil into a secondary oil chamber 5 disposed in the jack lifting shaft 3 in order to descend the jack lifting shaft 3. Although the double-acting jack can resume the jack lifting shaft 3 to its original position quickly, the pressure difference is very large, since the main oil chamber 2 has a cross-sectional area greater than the cross-sectional area of the secondary oil chamber 5. Therefore, if the pipeline is clogged and the user continues filling into the main oil chamber 2, the pipeline of the secondary oil chamber 5 will be clogged to result in an overpressure of the pipeline or damage the structure of the jack.

Therefore, it is a main subject for the present invention to develop a jack capable of discharging extra liquid from the jack appropriately when an overpressure caused by the clog of the pipeline occurs, so as to avoid damages to the jack.

### SUMMARY

In view of the aforementioned drawback of the conventional jack whose pipeline is clogged and over-pressured easily, it is an objective of the present invention to provide a jack capable of discharging extra liquid timely when an overpressure is resulted from a clog of the pipeline, in order to prevent the overpressure from damaging the jack.

To achieve the aforementioned and other objectives, the present invention provides an anti-overpressure double-acting threaded jack comprising an outer cylinder, an inner piston rod, a lifting piston rod, a limit element, a locking element and a pressure relief module.

The outer cylinder has a first liquid guiding hole, a second liquid guiding hole and a liquid discharge hole, formed on a sidewall of the outer cylinder.

The inner piston rod is installed at the center of the outer cylinder, and the inner piston rod comprises: an inner piston installed at the top of the inner piston rod; a liquid guiding pipeline installed in the inner piston rod; a first opening formed on a sidewall of the inner piston rod and communicated to the liquid guiding pipeline; a second opening formed on a sidewall of the inner piston rod and near the bottom of the inner piston rod and communicated to the liquid guiding pipeline and the second liquid guiding hole; and a third opening formed on a sidewall of the inner piston rod and near the bottom of the inner piston rod and communicated to the liquid guiding pipeline and the liquid discharge hole.

The lifting piston rod is movably sheathed on the inner piston rod, and the lifting piston rod comprises a jack platform disposed at the top of the lifting piston rod; a hydraulic seal cap, installed at the bottom of an inner sidewall of the lifting piston rod, wherein the hydraulic seal cap, the inner sidewall of the lifting piston rod, the outer sidewall of the inner piston rod and the inner piston form a first hydraulic chamber, and the first hydraulic chamber is communicated to the liquid guiding pipeline through the first opening; a lifting hydraulic piston, installed at the bottom of the outer sidewall of the lifting piston rod, wherein the lifting hydraulic piston, the bottom of the lifting piston rod, the hydraulic seal cap, the outer sidewall of the inner piston rod and the inner wall of the outer cylinder form a second hydraulic chamber, and the second hydraulic chamber is communicated to the first liquid guiding hole; and a limit portion, formed at the bottom of the outer sidewall of the lifting piston rod and disposed at the top of the lifting hydraulic piston; wherein the hydraulic seal cap is in a liquid tight frictional contact with the inner piston rod, and the inner piston is in a liquid tight frictional contact with the inner sidewall of the lifting piston rod, and the lifting hydraulic piston is in a liquid tight frictional contact with the inner sidewall of the outer cylinder.

The limit element is installed at the top of the outer cylinder and corresponding to the limit portion for limiting the lifting hydraulic piston of the lifting piston rod between the limit element and the bottom of the inner side of the outer cylinder.

The locking element is installed at the top of the outer cylinder and disposed at the top of the limit element for locking to the outer sidewall of the lifting piston rod.

The pressure relief module is installed between the liquid discharge hole of the outer cylinder and the third opening of the inner piston rod, and the pressure relief module comprises: an adjusting member secured into the liquid discharge hole and having a through hole formed thereon and communicated to the third opening; a stop member movably stopped at the third opening; and a spring installed between the adjusting member and the stop member, such that the adjusting member can be rotated to drive the spring to abut the stop member.

In the double-acting threaded jack, the first opening is near the top of the inner piston and disposed at the bottom of the inner piston.

In the double-acting threaded jack, the first liquid guiding hole is near the bottom of the outer cylinder.

In the double-acting threaded jack, a thread structure is formed on an outer sidewall of the lifting piston rod and disposed at the top of the limit portion. The double-acting threaded jack further comprises a thread element disposed between the limit element and the locking element and corresponding to the thread structure of the lifting piston rod.

In the double-acting threaded jack, the stop member is a sphere.

In summation, the double-acting threaded jack of the present invention come with the aforementioned design capable of discharging extra liquid in an overpressure situation caused by a clog of the pipeline, so as to prevent the jack from being damaged by overpressure.

### BRIEF DESCRIPTION

FIGS. 1 and 2 are schematic views showing the using status of a conventional double-acting jack;

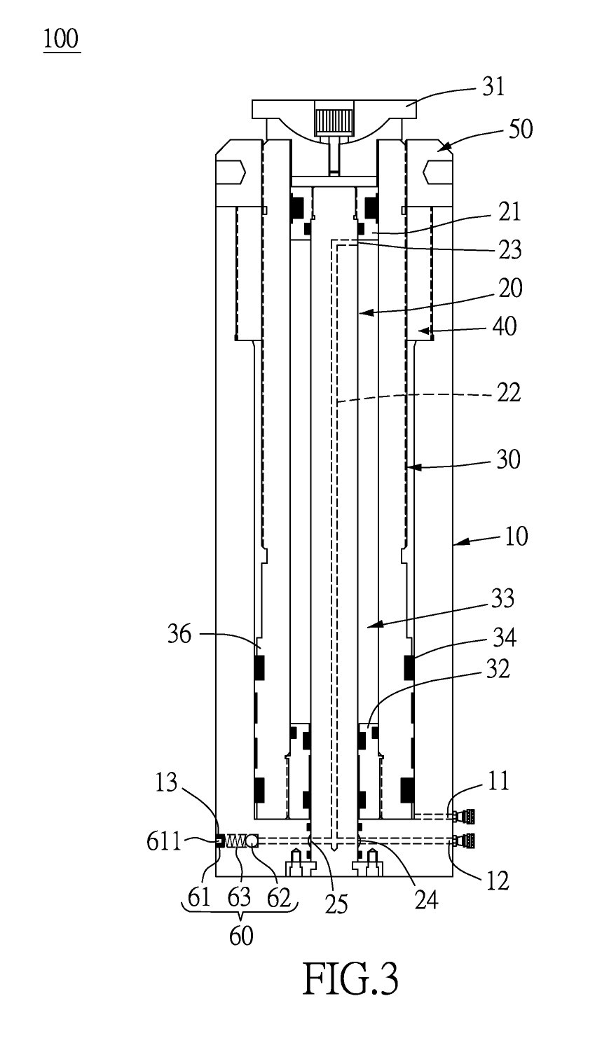

FIG. 3 is a sectional view of a double-acting threaded jack of a first preferred embodiment of the present invention;

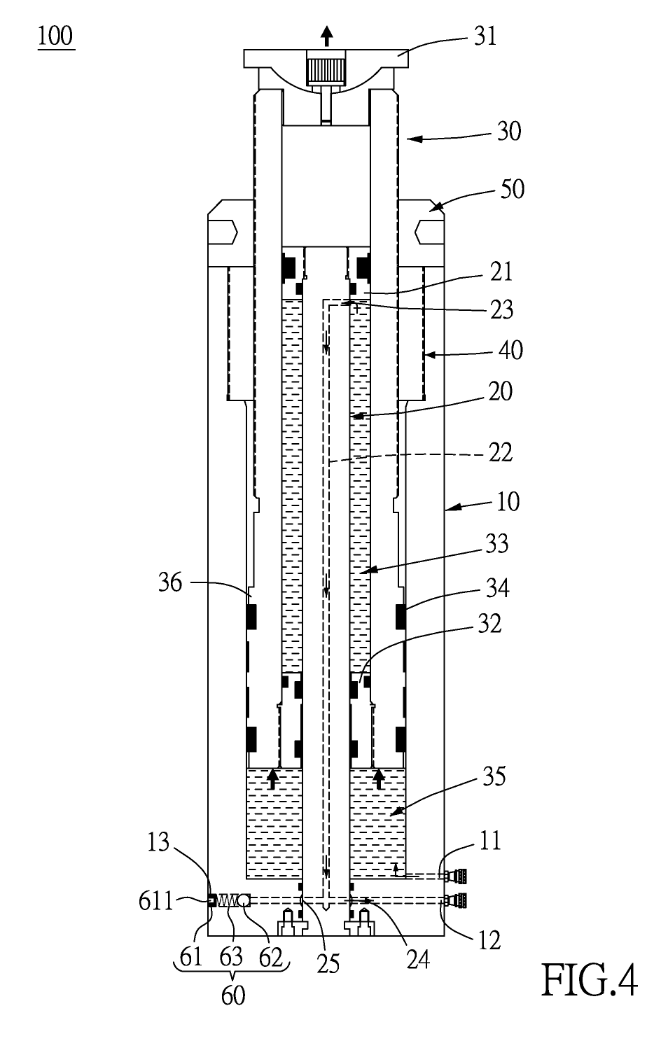

FIG. 4 is a schematic view of ascending a lifting piston rod in accordance with the first preferred embodiment of the present invention;

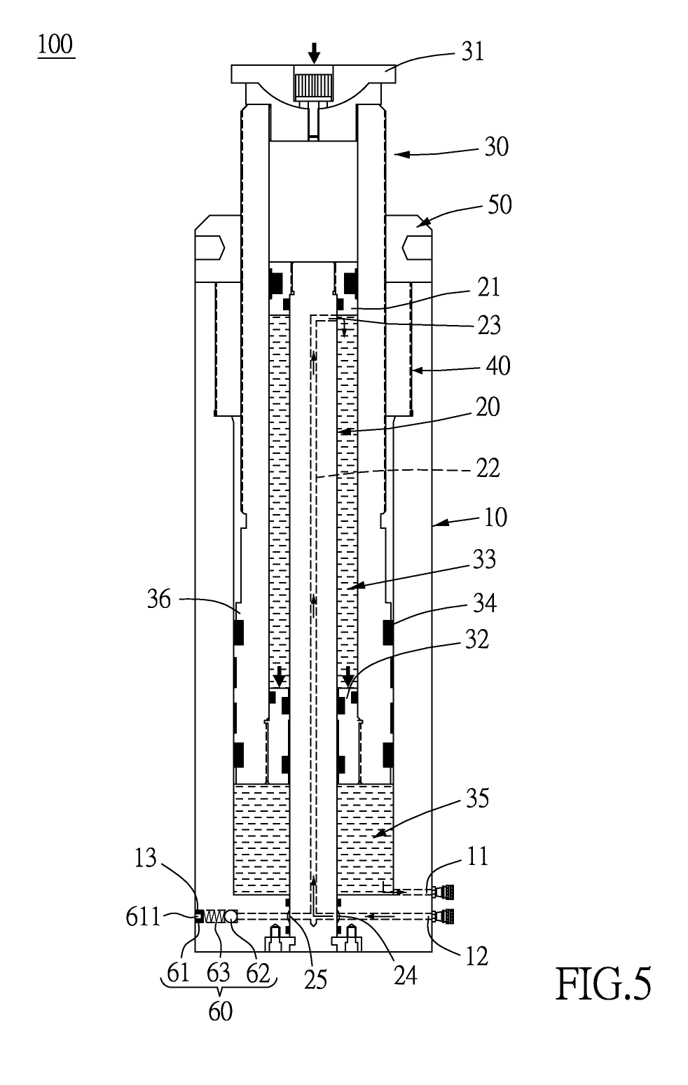

FIG. 5 is a schematic view of descending a lifting piston rod in accordance with the first preferred embodiment of the present invention;

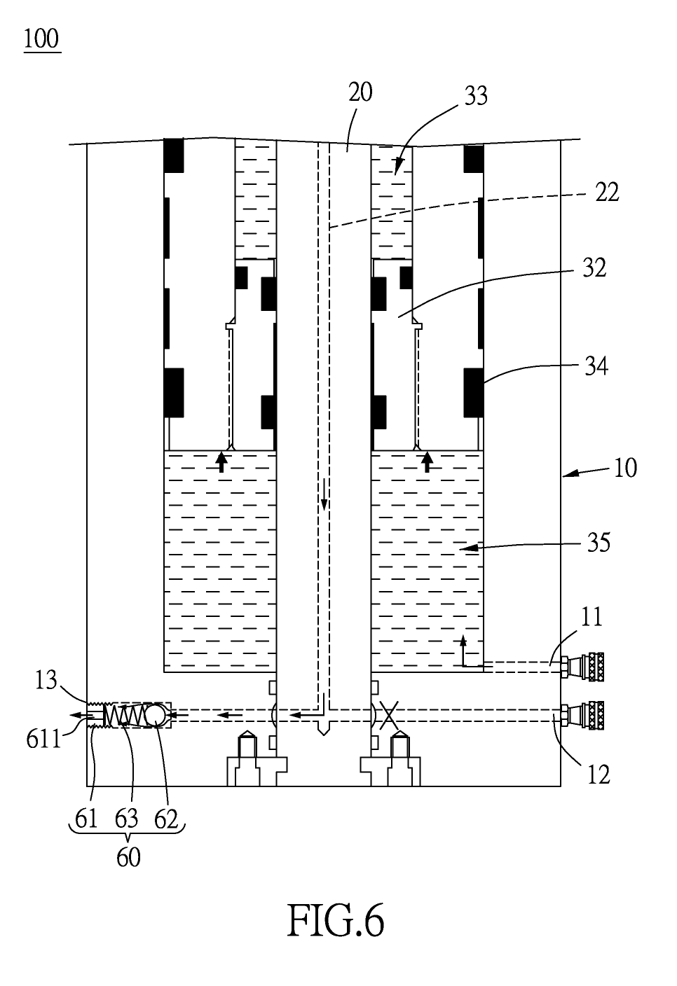

FIG. 6 is a schematic view showing the operation of a pressure relief module in accordance with the first preferred embodiment of the present invention; and

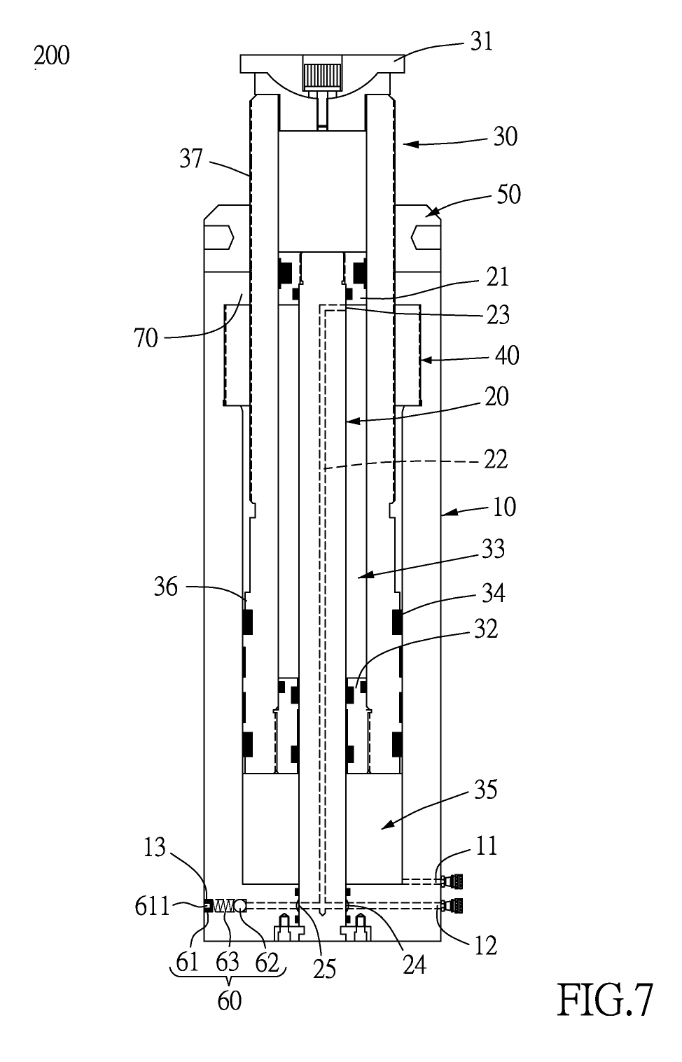

FIG. 7 is a sectional view of a double-acting threaded jack of a second preferred embodiment of the present invention.

### DETAILED DESCRIPTION

The objects, characteristics and effects of the present invention will become apparent with the detailed description of the preferred embodiments and the illustration of related drawings as follows.

With reference to FIGS. 3 to 5 for an anti-overpressure double-acting threaded jack in accordance with the first preferred embodiment of the present invention, the double-acting threaded jack 100 comprises an outer cylinder 10, an inner piston rod 20, a lifting piston rod 30, a limit element 40, a locking element 50 and a pressure relief module 60.

The outer cylinder 10 includes a first liquid guiding hole 11, a second liquid guiding hole 12 and a liquid discharge hole 13, all formed on a sidewall of the outer cylinder 10. The first liquid guiding hole 11 is preferably proximate to the bottom of the outer cylinder 10, and the first liquid guiding hole 11 is communicated to the interior of the outer cylinder 10. Even though it is not shown in the figure, the first liquid guiding hole 11 and the second liquid guiding hole 12 are coupled to a liquid tank (not shown in the figure) and a liquid pump (not shown in the figure). Wherein, the liquid contained in the liquid tank is a common liquid such as oil or water.

The inner piston rod 20 is installed at the center of the outer cylinder 10, and the inner piston rod 20 comprises: an inner piston 21, installed at the top of the inner piston rod 20, wherein the inner piston 21 may be a seal ring such as an O-ring; a liquid guiding pipeline 22, installed in the inner piston rod 20; a first opening 23, penetrating through a sidewall of the inner piston rod 20 and communicated to the liquid guiding pipeline 22, and more specifically, the first opening 23 is proximate to the top of the inner piston rod 20 and disposed under the inner piston 21; a second opening 24, penetrating through a sidewall of the inner piston rod 20 and disposed proximate to the bottom of the inner piston rod 20, and communicated to the liquid guiding pipeline 22 and the second liquid guiding hole 12; and a third opening 25, penetrating through a sidewall of the inner piston rod 20, and disposed proximate to the bottom of the inner piston rod 20, and communicated to the liquid guiding pipeline 22 and the liquid discharge hole 13.

The lifting piston rod 30 is movably sheathed on the inner piston rod 20, and the lifting piston rod 30 comprises: a jack platform 31 disposed at the top of the lifting piston rod 30 for lifting an object (not shown in the figure); a hydraulic seal cap 32 installed at the bottom of an inner sidewall of the lifting piston rod 30, wherein the hydraulic seal cap 32 is a seal ring such as an O-ring, and the hydraulic seal cap 32, the inner sidewall of the lifting piston rod 30, the outer sidewall of the inner piston rod 20 and the inner piston 21 form a first hydraulic chamber 33, and the first hydraulic chamber 33 is communicated to the liquid guiding pipeline 22 through the first opening 23; a lifting hydraulic piston 34 installed at the bottom of the outer sidewall of the lifting piston rod 30, wherein the lifting hydraulic piston 34 is a seal ring such as an O-ring, and the lifting hydraulic piston 34, the bottom of the lifting piston rod 30, the hydraulic seal cap 32, the outer sidewall of the inner piston rod 20 and the inner wall of the outer cylinder 10 form a second hydraulic chamber 35, and the second hydraulic chamber 35 is communicated to the first liquid guiding hole 11; and a limit portion 36 formed at the bottom of the outer sidewall of the lifting piston rod 20 and disposed at the top of the lifting hydraulic piston 35, wherein the hydraulic seal cap 32 is in a liquid tight frictional contact with the inner piston rod 20, and the inner piston 21 is in a liquid tight frictional contact with the inner sidewall of the lifting piston rod 30, and the lifting hydraulic piston 35 is in a liquid tight frictional contact with the inner sidewall of the outer cylinder 10.

The limit element 40 is installed at the top of the outer cylinder 10 and corresponding to the limit portion 36 of the lifting piston rod 30 for limiting the lifting hydraulic piston 35 of the lifting piston rod 30 between the limit element 40 and the bottom of the inner side of the outer cylinder 10.

The locking element 50 is installed at the top of the outer cylinder 10 and disposed at the top of the limit element 40 for locking to the outer sidewall of lifting piston rod 30.

The pressure relief module 60 is installed between the liquid discharge hole 13 of the outer cylinder 10 and the third opening 25 of the inner piston rod 20, and the pressure relief module 60 comprises an adjusting member 61 secured into the liquid discharge hole 13, and the adjusting member 61 includes a through hole 611 communicated to the third opening 25, and more specifically, the adjusting member 61 is a nut with an external thread; a stop member 62, movably stopped at the third opening 25, wherein the stop member 62 is a sphere as shown in FIG. 3. It is noteworthy that the invention is not limited to the sphere only, but a piston or a block can be used as well; and a spring 63, installed between the adjusting member 61 and the stop member 62. By rotating along the thread, the adjusting member 61 is provided for driving the spring 63 to abut the stop member 62. More specifically, when the distance between the adjusting member 61 and the stop member 62 becomes shorter, the compression force produced by the spring 63 becomes greater, so that a greater pushing force is applied to the stop member 62 to maintain the sealing condition of the third opening 25.

Refer to FIGS. 4 and 5 for the operation of the double-acting threaded jack 100. In FIG. 4, when a user needs to lift the lifting piston rod 30, the user uses a hydraulic pump (not shown in the figure) to pump a liquid from a tank into the second hydraulic chamber 35 through the first liquid guiding hole 11. When the liquid in the second hydraulic chamber 35 increases, the lifting piston rod 30 is lifted to ascend the lifting piston rod, and the liquid in the first hydraulic chamber 33 will flow through the first opening 23, the liquid guiding pipeline 22, and the second opening 24 sequentially and out from the second liquid guiding hole 12.

In FIG. 5, when the user needs to descend a lifted lifting piston rod 30, the user uses a hydraulic pump (not shown in the figure) to fill the liquid into a tank through the second liquid guiding hole 12, so that the liquid flows through the second opening 24 and the liquid guiding pipeline 22 to the first opening 23 and then into the first hydraulic chamber 33. When the liquid in the first hydraulic chamber 33 increases, the lifting piston rod 30 descends, and the liquid in the second hydraulic chamber 35 will flow out from the first liquid guiding hole 11.

In the description above, a liquid is filled from the first liquid guiding hole 11 or the second liquid guiding hole 12 to adjust the height of the lifting piston rod 30, and when the height of the lifting piston rod 30 reaches an expected height, the user can lock the outer sidewall of the lifting piston rod 30 by the locking element 50 to fix the position of the lifting piston rod 30, and the height of the jack platform 31 can be fixed as well. The design of the limit element 40 has the effect of preventing the user to fill too much liquid into the second hydraulic chamber 35 which may cause the lifting piston rod 30 to separate from the outer cylinder 10.

In FIGS. 4 and 6, when the user fills the liquid from the first liquid guiding hole 11 into the second hydraulic chamber 35, the liquid in the first hydraulic chamber 33 is compressed to flow into the liquid guiding pipeline 22. Since the compressed surface of the second hydraulic chamber 35 is different from the compressed surface of the first hydraulic chamber 33, therefore when the liquid in the first hydraulic chamber 33 is compressed to flow into the liquid guiding pipeline 22 and the second liquid guiding hole 12 is clogged or the liquid is not discharged out from the second liquid guiding hole 12 fast enough, the liquid in the liquid guiding pipeline 22 cannot be discharged in time to cause an overpressure condition. In FIG. 6, the pressure produced by the liquid in the liquid guiding pipeline 22 will resist the pushing force of the spring 63 to push open the stop member 62, so that the liquid flows out from the through hole 611 of the adjusting member 61. By the aforementioned operation, the effect of releasing pressure can be achieved. If the pressure produced by the liquid of the liquid guiding pipeline 22 is smaller than the pushing force produced by the spring 63, the stop member 62 will seal the third opening 25 again.

In summation, the anti-overpressure double-acting threaded jack of the present invention comes with the design of the pressure relief module capable of discharging extra liquid in an overpressure situation caused by a clog of the liquid guiding pipeline, so as to prevent the overpressure condition from damaging the double-acting threaded jack.

With reference to FIG. 7 for an anti-overpressure double-acting threaded jack in accordance with the second preferred embodiment of the present invention, the design of the double-acting threaded jack 200 of this preferred embodiment is substantially the same as the double-acting threaded jack 100 of the first preferred embodiment, except that the outer sidewall of the lifting piston rod 30 further includes a thread structure 37 disposed at the top of the limit portion 36, and the double-acting threaded jack 200 further comprises a thread element 70 disposed between the limit element 40 and the locking element 50 and corresponding to the thread structure 37 of the lifting piston rod 30.

When the user fills the liquid into the second hydraulic chamber 35, the lifting piston rod 30 can be ascended through the design of the thread element 70 and the thread structure 37.

In summation of the description above, the anti-overpressure double-acting threaded jack of the present invention can discharge extra liquid through the design of the pressure relief module in an overpressure situation caused by a clog of the liquid guiding pipeline, so as to prevent the overpressure situation from damaging the double-acting threaded jack. In addition, the design of the thread element and the thread structure can achieve the ascending and descending effects.

While the invention has been described by means of specific embodiments, numerous modifications and variations could be made thereto by those skilled in the art without departing from the scope and spirit of the invention set forth in the claims.

What is claimed is:

1. An anti-overpressure double-acting threaded jack, comprising:
an outer cylinder, having a first liquid guiding hole, a second liquid guiding hole and a liquid discharge hole, formed on a sidewall of the outer cylinder;
an inner piston rod, installed at the center inside the outer cylinder, and having:
an inner piston, installed at the top of the inner piston rod;
a liquid guiding pipeline, installed in the inner piston rod;
a first opening, formed on a sidewall of the inner piston rod, communicated to the liquid guiding pipeline;
a second opening, formed on a sidewall of the inner piston rod and proximate to the bottom of the inner piston rod, and communicated to the liquid guiding pipeline and the second liquid guiding hole; and
a third opening, formed on a sidewall of the inner piston rod and proximate to the bottom of the inner piston rod, and communicated to the liquid guiding pipeline and the liquid discharge hole;
a lifting piston rod, movably sheathed on the inner piston rod, and having:
a jack platform, disposed at the top of the lifting piston rod;
a hydraulic seal cap, installed at the bottom of an inner sidewall of the lifting piston rod, and the hydraulic seal cap, the inner sidewall of the lifting piston rod, the outer sidewall of the inner piston rod, and the inner piston forming a first hydraulic chamber, and the first hydraulic chamber communicating to the liquid guiding pipeline through the first opening;
a lifting hydraulic piston, installed at the bottom of an outer sidewall of the lifting piston rod, and the lifting hydraulic piston, the bottom of the lifting piston rod, the hydraulic seal cap, the outer sidewall of the inner piston rod and the inner wall of the outer cylinder forming a second hydraulic chamber, and the second hydraulic chamber communicating to the first liquid guiding hole; and
a limit portion, formed at the bottom of the outer sidewall of the lifting piston rod, and disposed at the top of the lifting hydraulic piston; wherein the hydraulic seal cap is in a liquid tight frictional contact with the outer sidewall of the inner piston rod, and the inner piston is in a liquid tight frictional contact with the inner sidewall of the lifting piston rod, and the lifting hydraulic piston is in a liquid tight frictional contact with the inner sidewall of the outer cylinder;
a limit element, installed at the top of the outer cylinder and corresponding to the limit portion, for limiting the lifting hydraulic piston of the lifting piston rod between the limit element and the bottom of the inner side of the outer cylinder;
a locking element, installed at the top of the outer cylinder, and disposed at the top of the limit element, for locking the outer sidewall of the lifting piston rod; and
a pressure relief module, installed between the liquid discharge hole of the outer cylinder and the third opening of the inner piston rod, and having:
an adjusting member, secured into the liquid discharge hole, and having a through hole formed thereon and communicated to the third opening;
a stop member, movably stopped at the third opening; and
a spring, installed between the adjusting member and the stop member, for abutting against the stop member by rotating the adjusting member.

2. The double-acting threaded jack of claim 1, wherein the first opening is proximate to the top of the inner piston rod and disposed below the inner piston.

3. The double-acting threaded jack of claim 1, wherein the first liquid guiding hole is proximate to the bottom of the outer cylinder.

4. The double-acting threaded jack of claim 2, wherein the first liquid guiding hole is proximate to the bottom of the outer cylinder.

5. The double-acting threaded jack of claim 1, wherein the outer sidewall of the lifting piston rod further has a thread structure disposed at the top of the limit portion, and the double-acting threaded jack further comprises a thread element disposed between the limit element and the locking element, and corresponding to the thread structure of the lifting piston rod.

6. The double-acting threaded jack any of claim 2, wherein the outer sidewall of the lifting piston rod further has a thread structure disposed at the top of the limit portion, and the double-acting threaded jack further comprises a thread element disposed between the limit element and the locking element, and corresponding to the thread structure of the lifting piston rod.

7. The double-acting threaded jack of claim 3, wherein the outer sidewall of the lifting piston rod further has a thread structure disposed at the top of the limit portion, and the double-acting threaded jack further comprises a thread element disposed between the limit element and the locking element, and corresponding to the thread structure of the lifting piston rod.

8. The double-acting threaded jack of claim 4, wherein the outer sidewall of the lifting piston rod further has a thread structure disposed at the top of the limit portion, and the double-acting threaded jack further comprises a thread element disposed between the limit element and the locking element, and corresponding to the thread structure of the lifting piston rod.

9. The double-acting threaded jack of claim 1, wherein the stop member is a sphere.

10. The double-acting threaded jack of claim 2, wherein the stop member is a sphere.

11. The double-acting threaded jack of claim 3, wherein the stop member is a sphere.

12. The double-acting threaded jack of claim 4, wherein the stop member is a sphere.

13. The double-acting threaded jack of claim 5, wherein the stop member is a sphere.

14. The double-acting threaded jack of claim 6, wherein the stop member is a sphere.

15. The double-acting threaded jack of claim 7, wherein the stop member is a sphere.

16. The double-acting threaded jack of claim 8, wherein the stop member is a sphere.
